(19) United States
(12) Patent Application Publication
(10) Pub. No.: US 2014/0134461 A1
(43) Pub. Date: May 15, 2014

(54) SECONDARY BATTERY

(71) Applicants: Kazuhiko Inoue, Tokyo (JP); Hiroshi Hatakeyama, Tokyo (JP); Takehiro Noguchi, Tokyo (JP)

(72) Inventors: Kazuhiko Inoue, Tokyo (JP); Hiroshi Hatakeyama, Tokyo (JP); Takehiro Noguchi, Tokyo (JP)

(21) Appl. No.: 14/130,063

(22) PCT Filed: Jun. 5, 2012
(86) PCT No.: PCT/JP2012/064474

§ 371 Date: Dec. 30, 2013

(30) Foreign Application Priority Data
Jul. 4, 2011 (JP) 2011-148174
Sep. 15, 2011 (JP) 2011-202092

(51) Int. Cl. H01M 2/26; H01M 10/04

(52) U.S. Cl. CPC H01M 2/26; H01M 10/04
USPC 429/7; 429/160; 29/623.1

(57) ABSTRACT

A secondary battery having high heat dissipation ability is provided. A secondary battery including a plurality of positive electrodes and a plurality of negative electrodes in an outer package, wherein the plurality of positive electrodes are connected to each other outside the outer package without being connected to each other inside the outer package, or wherein the plurality of negative electrodes are connected to each other outside the outer package without being connected to each other inside the outer package, or wherein the plurality of positive electrodes are connected to each other outside the outer package without being connected to each other inside the outer package and the plurality of negative electrodes are connected to each other outside the outer package without being connected to each other inside the outer package. In addition, the secondary battery, wherein the plurality of positive electrodes are connected to each other outside the outer package without being connected to each other inside the outer package, the outer package includes an electrolytic solution containing an additive, the plurality of positive electrodes contain lithium, and the plurality of positive electrodes are connected to each other outside the outer package after a potential is applied to at least one positive electrode between the plurality of positive electrodes until a potential equal to or less than a potential at which the additive is reductively decomposed is reached.

### TECHNICAL FIELD

The present exemplary embodiment relates to a secondary battery.

### BACKGROUND ART

Secondary batteries, such as lithium secondary batteries and lithium ion secondary batteries, have the features of small size and large capacity, and are widely used as power supplies for cellular phones, notebook computers, and the like. With such expansion of applications, still higher capacity and an improvement in cycle characteristics are desired for secondary batteries.

As one approach for higher capacity, increasing the charge voltage is considered. However, at a high potential, the electrolytic solution decomposes on the positive electrode, and the cycle characteristics of the secondary battery may decrease.

Patent Literature 1 discloses a method for suppressing the decomposition of the electrolytic solution on the positive electrode at a high potential, including assembling a secondary battery and then reductively decomposing an additive in a nonaqueous electrolytic solution containing the additive by overdischarge to form a film on the positive electrode surface.

Meanwhile, because of higher capacity of secondary batteries, an increase in the amount of heat generation due to an internal short circuit and an external short circuit is expected, and therefore an improvement in safety is required. Particularly in vehicle applications, such as automobiles, higher capacity is essential for extending the cruising range, and it is necessary to ensure higher safety. When a short circuit or the like occurs and heat generates inside a secondary battery, the electrolytic solution may burn. Therefore, the development of a secondary battery having high ability of heat dissipation and safety is desired.

Patent Literature 2 discloses a technique of laminating current collectors and allowing the current collectors to have a heat dissipation function. Patent Literature 3 discloses a method for preventing an external short circuit, including mounting a current interruption apparatus outside a battery. In addition, the energy source of heat generated by an internal short circuit is the energy which is stored in the electrodes, and therefore, Patent Literatures 4 and 5 disclose a method including dividing an electrode into small portions, and providing a current interruption apparatus to each cell, thereby to limit the amount of heat generation due to an internal short circuit to a minimum, that is, to the energy of the small divided portions.

### CITATION LIST

### Patent Literature

Patent Literature 1: JP2009-164082A
Patent Literature 2: JP2009-117105A
Patent Literature 3: JP3210593B
Patent Literature 4: JP10-172574A
Patent Literature 5: JP2011-71045A

### SUMMARY OF INVENTION

### Technical Problem

However, when a secondary battery is assembled and then a film is formed on the positive electrode surface by overdischarge by the method described in Patent Literature 1, the following problems occur. When the negative electrode of the secondary battery contains no lithium, the electrolytic solution decomposes to generate a gas, and therefore, the secondary battery expands, which results in operation failure. In addition, a metal, such as copper, contained in the negative electrode current collector melts, and dendrites of copper or the like form in charge and discharge, which results in a short circuit or burning. On the other hand, when the negative electrode is lithium metal, dendrites of lithium form due to repeated charge and discharge, and a short circuit occurs. In addition, when the negative electrode contains lithium, for example, when the negative electrode is predoped with lithium, the negative electrode potential becomes so high that a metal, such as copper, contained in the negative electrode current collector melts, which is particularly observed in the case where the amount of predoping is not sufficient. As a result, dendrites of copper or the like form in charge and discharge, and therefore, a short circuit or burning occurs. In addition, by the desorption of lithium in the process of charge and discharge, the decomposition of the electrolytic solution, and the melting of the metal, such as copper, contained in the negative electrode current collector occur as in the case where the negative electrode contains no lithium. Therefore, in the method described in Patent Literature 1, the problems occur regardless of the type of the negative electrode, and thus, the cycle characteristics of the secondary battery decrease.

In addition, the battery disclosed in Patent Literature 2 has a structure in which the connection portion between bipolar batteries that are assemblies of unit batteries is cooled, and the unit batteries are not connected outside the outer package, which brings low cooling efficiency. In the battery disclosed in Patent Literature 3, when a short circuit occurs inside due to an external force, such as impact, or when an internal short circuit occurs due to the formation of dendrites, or the like, the current interruption apparatus does not function. The battery disclosed in Patent Literature 4 is a so-called wound type battery manufactured by winding electrodes, and when a short circuit occurs in the central portion, heat generation also occurs in the central portion. Therefore, a sufficient heat dissipation effect is not obtained. In other words, the cooling of the central layer is not sufficient, and the electrolytic solution may burn. The battery disclosed in Patent Literature 5 is a laminated type battery having higher cooling efficiency than a wound type, and the electrode tab inside the battery is processed to provide a current interruption apparatus. In other words, the battery disclosed in Patent Literature 5 is a system in which the electrode tab is melted and cut by an excess current flow thereby to cut the current circuit. Therefore, heat is generated inside the battery during operation, and due to this heat, the electrolytic solution may burn.

Therefore, even if the techniques disclosed in Patent Literatures 2 to 5 are applied, sufficient heat dissipation ability and safety cannot be obtained, and further development is desired. It is an object of the present exemplary embodiment to provide a secondary battery having high heat dissipation ability.

### Solution to Problem

A secondary battery according to the present exemplary embodiment is a secondary battery including a plurality of positive electrodes and a plurality of negative electrodes in an outer package, wherein the plurality of positive electrodes are connected to each other outside the outer package without being connected to each other inside the outer package, or wherein the plurality of negative electrodes are connected to each other outside the outer package without being connected to each other inside the outer package, or wherein the plurality of positive electrodes are connected to each other outside the outer package without being connected to each other inside the outer package and the plurality of negative electrodes are connected to each other outside the outer package without being connected to each other inside the outer package.

A method for manufacturing a secondary battery according to the present exemplary embodiment is a method for manufacturing a secondary battery comprising a plurality of positive electrodes and a plurality of negative electrodes in an outer package, including: assembling a pre-connected secondary battery without connecting the plurality of positive electrodes to each other inside the outer package, or without connecting the plurality of negative electrodes to each other inside the outer package, or without connecting the plurality of positive electrodes to each other inside the outer package and without connecting the plurality of negative electrodes to each other inside the outer package; and connecting the plurality of positive electrodes not connected to each other inside the outer package in the pre-connected secondary battery, or connecting the plurality of negative electrodes not connected to each other inside the outer package in the pre-connected secondary battery, or connecting the plurality of positive electrodes not connected to each other inside the outer package in the pre-connected secondary battery and connecting the plurality of negative electrodes not connected to each other inside the outer package in the pre-connected secondary battery, to each other outside the outer package.

### Advantageous Effect of Invention

According to the present exemplary embodiment, a secondary battery having high heat dissipation ability can be provided.

### BRIEF DESCRIPTION OF DRAWINGS

FIG. 1 is a cross-sectional view showing one example of a secondary battery according to the present exemplary embodiment.

FIG. 2 shows diagrams showing one example of the configuration of the positive electrode tabs and negative electrode tabs of the secondary battery according to the present exemplary embodiment.

FIG. 3 is a diagram showing a graph of one example of alternate application according to the present exemplary embodiment.

FIG. 4 shows diagrams showing the shapes of positive electrodes, a negative electrode, and a separator in the present Example.

FIG. 5 is an exploded perspective view showing the lamination pattern of the positive electrodes, negative electrode, and separators of a secondary battery in the present Example.

FIG. 6 is a diagram showing the state of the injection of the electrolytic solution of the secondary battery in the present Example.

FIG. 7 is a cross-sectional view showing the secondary battery in the present Example.

FIG. 8 is a cross-sectional view showing one example of a secondary battery including overcurrent protection circuits according to the present exemplary embodiment.

FIG. 9 shows diagrams showing the shapes of negative electrodes in the present Example.

FIG. 10 shows diagrams showing the shapes of positive electrodes and a separator in the present Example.

FIG. 11 is an exploded perspective view showing the lamination pattern of the positive electrodes, negative electrodes, and separators of a secondary battery in the present Example.

FIG. 12 is a diagram showing the state of the injection of the electrolytic solution of the secondary battery in the present Example.

FIG. 13 is a cross-sectional view showing the secondary battery in the present Example.

FIG. 14 is a cross-sectional view showing one example of a vehicle according to the present exemplary embodiment.

### DESCRIPTION OF EMBODIMENTS

### Secondary Battery

A secondary battery according to the present exemplary embodiment is a secondary battery including a plurality of positive electrodes and a plurality of negative electrodes in an outer package, wherein the plurality of positive electrodes are connected to each other outside the outer package without being connected to each other inside the outer package, or wherein the plurality of negative electrodes are connected to each other outside the outer package without being connected to each other inside the outer package, or wherein the plurality of positive electrodes are connected to each other outside the outer package without being connected to each other inside the outer package, and the plurality of negative electrodes are connected to each other outside the outer package without being connected to each other inside the outer package.

In the present exemplary embodiment, the plurality of positive electrodes are extended to the outside of the outer package and connected to each other outside the outer package without being connected to each other inside the outer package, or the plurality of negative electrodes are extended to the outside of the outer package and connected to each other outside the outer package without being connected to each other inside the outer package, or the plurality of positive electrodes are extended to the outside of the outer package and connected to each other outside the outer package without being connected to each other inside the outer package and the plurality of negative electrodes are extended to the outside of the outer package and connected to each other outside the outer package without being connected to each other inside the outer package, and thus, an corresponding area to the number of at least one of the positive electrodes and the negative electrodes are exposed to the outside of the outer package. Therefore, even if heat is generated due to the occurrence of a short circuit or the like inside the secondary battery, heat is sufficiently dissipated to the outside through at least one of the positive electrodes and the negative electrodes. Thus, the highest temperature reached inside the secondary battery can be decreased, and the burning of the electrolytic solution can be avoided, and therefore, the safety of the secondary battery can be improved. It should be noted that “connection” herein means electrical connection. Therefore, for example, the positive electrode current collectors of the positive electrodes may be extended to the outside of the outer package and connected to each other outside the outer package without being connected to each other inside the outer package, or alternatively, for example, positive electrode tabs connected to the positive electrode current collectors of the positive electrodes, respectively, inside the outer package may be extended to the outside of the outer package and connected to each other outside the package without being connected to each other inside the outer package. The same applies to the negative electrode.

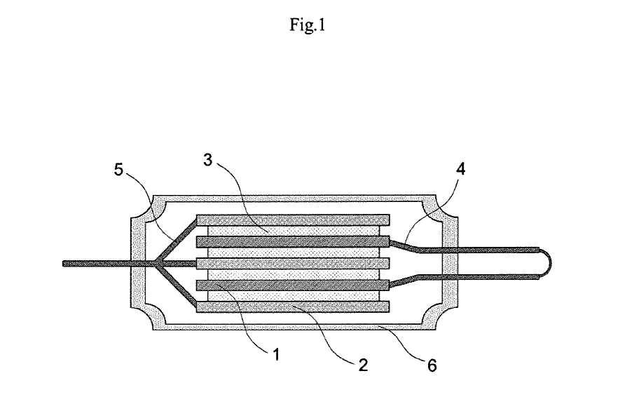

The configuration of the secondary battery according to the present exemplary embodiment is not particularly limited as long as it is a secondary battery including a plurality of positive electrodes and a plurality of negative electrodes in an outer package, wherein the plurality of positive electrodes are connected to each other outside the outer package without being connected to each other inside the outer package, or wherein the plurality of negative electrodes are connected to each other outside the outer package without being connected to each other inside the outer package, or wherein the plurality of positive electrodes are connected to each other outside the outer package without being connected to each other inside the outer package, and the plurality of negative electrodes are connected to each other outside the outer package without being connected to each other inside the outer package. The secondary battery according to the present exemplary embodiment can be, for example, a secondary battery shown in FIG. 1. The secondary battery shown in FIG. 1 includes a plurality of positive electrodes 1 and a plurality of negative electrodes 2. A separator 3 is sandwiched between the positive electrode 1 and the negative electrode 2 so as not to make electrical connection. The positive electrodes 1 and the negative electrodes 2 are in a state of being immersed in an electrolytic solution not shown, and these are hermetically sealed in an outer package 6. The positive electrodes 1 are connected to positive electrode tabs 4, and the negative electrodes 2 are connected to negative electrode tabs 5 in the outer package 6. The positive electrode tabs 4 connected to the positive electrodes 1 are extended to the outside of the outer package 6 in a state of being not connected to each other inside the outer package 6, and are connected outside the outer package 6. On the other hand, the negative electrode tabs 2 connected to the negative electrodes 2 are extended to the outside of the outer package 6 in a state of being connected to each other inside the outer package 6. The connection between the positive electrodes 1 and the positive electrode tabs 4 may be made outside the outer package 6. The secondary battery according to the present exemplary embodiment is not limited to this exemplary embodiment, and it should be noted that the negative electrodes 2 also may be connected to each other outside the outer package 6.

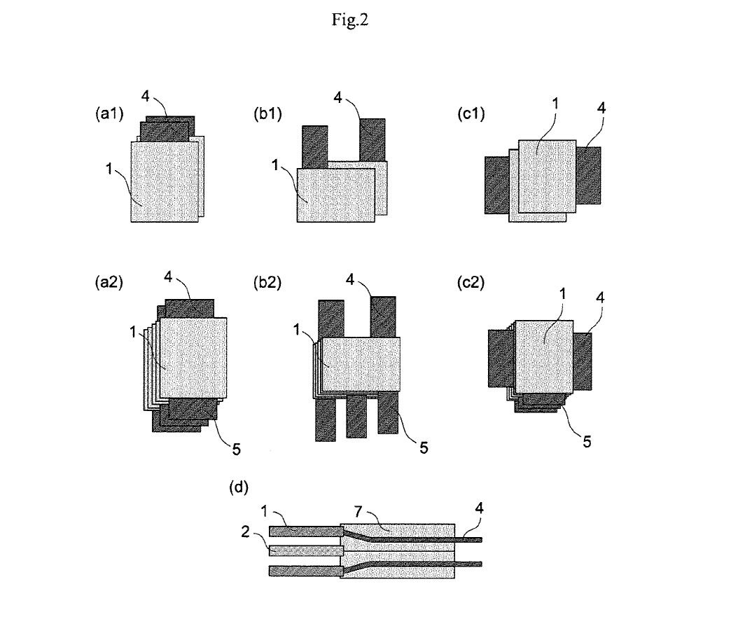

When the positive electrode tabs 4 connected to the positive electrodes 1 are extended to the outside of the outer package 6 in a state of being not connected to each other inside the outer package 6, for example, the positive electrode tabs 4 may be connected to the positive electrodes 1 in the same direction, as shown in FIG. 2(a1). As shown in FIG. 2(b1), positions at which the positive electrode tabs 4 are extended to the outside of the outer package 6 may be made to be different from each other by connecting one positive electrode tab 4 to one end of one positive electrode 1, and connecting the other positive electrode tab 4 to the opposite end of the other positive electrode 1. As shown in FIG. 2(c1), directions in which the positive electrode tabs 4 are extended to the outside of the outer package 6 may be made to be different from each other by connecting one positive electrode tab 4 to one side of one positive electrode 1, and connecting the other positive electrode tab 4 to the different side of the other positive electrode 1. The negative electrodes 2 can also have similar configurations. Configurations in which these patterns are laminated respectively are shown in FIGS. 2(a2), (b2), and (c2). Further a method wherein covering the positive electrode tabs 4 with an insulating coat 7 so that the positive electrode tabs 4 are not connected to each other inside the outer package 6, as shown in FIG. 2(d), may be employed. The negative electrodes 2 can also have a similar configuration. The present exemplary embodiment is not limited to these configurations of the exemplary embodiment.

In the present exemplary embodiment, particularly, it is preferred, in terms of improving the heat dissipation effect, that the plurality of positive electrodes connected to each other outside the outer package without being connected to each other inside the outer package, or the plurality of negative electrodes connected to each other outside the outer package without being connected to each other inside the outer package, or the plurality of positive electrodes connected to each other outside the outer package without being connected to each other inside the outer package and the plurality of negative electrodes connected to each other outside the outer package without being connected to each other inside the outer package, are extended to the outside of the outer package in different directions from each other. For example, when the outer package has a plurality of sides, at least one of the plurality of positive electrodes and the plurality of negative electrodes can be extended to the outside of the outer package from two or three sides. For example, FIG. 2(c2) corresponds to such a case. The electrodes are extended in different directions from each other, which enables the electrodes to come into contact with the outside air more efficiently, and therefore, the heat dissipation effect is further improved.

It is preferred that the secondary battery according to the present exemplary embodiment is a secondary battery wherein the plurality of positive electrodes are connected to each other outside the outer package without being connected to each other inside the outer package, the outer package contains an electrolytic solution containing an additive, the positive electrodes contain lithium, and the positive electrodes are connected to each other outside the outer package after a potential is applied to at least one positive electrode between the positive electrodes until a potential equal to or less than a potential at which the additive is reductively decomposed is reached.

As described above, in the case where a secondary battery is assembled and then the positive electrode is overdischarged between the positive electrode and the negative electrode to form a film, the above-described problems occur regardless of the type of the negative electrode, and the cycle characteristics of the secondary battery decrease. In the method according to the present exemplary embodiment, a potential is applied to at least one positive electrode between the positive electrodes not connected to each other until a potential equal to or less than the potential at which the additive is reductively decomposed is reached, thereby to form a film on the positive electrode surface, and therefore, a film can be formed on the positive electrode surface without causing the problems. Thus, a secondary battery having high cycle characteristics can be provided.

The additive according to the present exemplary embodiment is not particularly limited as long as it is reductively decomposed at a predetermined potential and can form a film on the positive electrode surface. Examples of the additive include cyclic disulfonates, such as methylene methane disulfonate (MMDS) represented by the following formula (1), ethylene methane disulfonate, and propane methane disulfonate, cyclic sulfonates, such as 1,3-propane sultone, propene sultone, and butane sultone, cyclic sulfones, such as sulfolane, cyclic halogenated carbonates, such as fluorinated ethylene carbonate (FEC) represented by the following formula (2), trifluoromethyl propylene carbonate, and chloroethylene carbonate, unsaturated carbonates, such as vinylene carbonate (VC), vinyl ethylene carbonate, phenylene carbonate, and allyl methyl carbonate (AMC), acid anhydrides, such as maleic anhydride, succinic anhydride, and phthalic anhydride, cyclic imides, such as succinimide, lithium bisoxalate borate (LiBOB) represented by the following formula (3), lithium difluoro[oxalato-O,O′]borate (LiBF₂(C₂O₄)), sulfites, such as ethylene sulfite (ES), vinyl ethylene sulfite, butylene sulfite, dimethyl sulfite, and diethyl sulfite, unsaturated esters, such as vinyl acetate and divinyl adipate (ADV), glycolides, such as dimethyl glycolide and tetramethyl glycolide, and cyanofuran. Among these, at least one selected from the group consisting of MMDS, FEC, LiBOB, ES, VC, AMC, and ADV is preferred. One of these may be used, or two or more of these may be used in combination.

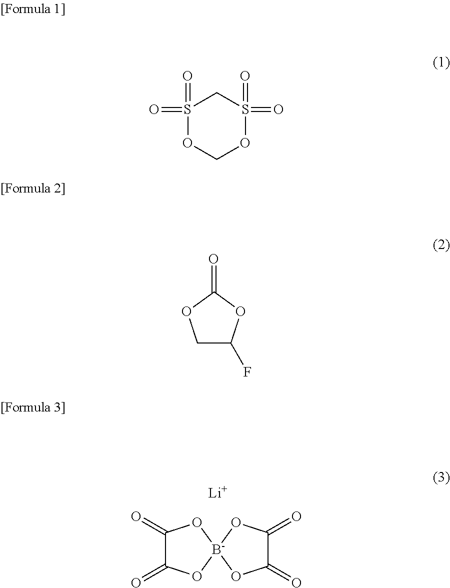 [SMILES: O=S1(=O)CS(=O)(=O)OCO1 ; O=C1OCC(F)O1 ; [Li+] ; O=C1O[B-]2(OC1=O)OC(=O)C(=O)O2]

The reduction potential (V vs Li/Li⁺) at which the reductive decomposition of MMDS starts is 1.5 V. The reduction potential (V vs Li/Li⁺) at which the reductive decomposition of FEC starts is 0.34 V. The reduction potential (V vs Li/Li⁺) at which the reductive decomposition of LiBOB starts is 2.0 V. The reduction potential (V vs Li/Li⁺) at which the reductive decomposition of ES starts is 2.5 V. The reduction potential (V vs Li/Li⁺) at which the reductive decomposition of VC starts is 2.0 V. The reduction potential (V vs Li/Li⁺) at which the reductive decomposition of AMC starts is 2.0 V. The reduction potential (V vs Li/Li⁺) at which the reductive decomposition of ADV starts is 2.0 V.

The reduction potential at which the additive is reductively decomposed can be measured in accordance with the cyclic voltammetry method. In the present exemplary embodiment, “a potential equal to or less than a potential at which the additive is reductively decomposed” means a potential equal to or less than a reduction potential at which the reductive decomposition of the additive starts.

In the present exemplary embodiment, the type of the positive electrode on the surface of which a film is formed by the reductive decomposition of the additive is not particularly limited as long as lithium is contained. As the positive electrode active material contained in the positive electrode, for example, lithium-containing complex oxides having a layer structure, such as LiMnO₂ and LiₓMn₂O₄ (0<x<2), lithium-containing complex oxides having a spinel structure, LiCoO₂, LiNiO₂, compounds in which part of the transition metals of these are replaced by other metals, olivine compounds, such as LiFePO₄ and LiMnPO₄, and Li₂MSiO₄ (M: at least one of Mn, Fe, and Co) can be used. One of these can be used, or two or more of these can be used in combination. However, as the positive electrode active material contained in the positive electrode, lithium-containing complex oxides having a spinel structure are preferred because they exhibit a high operating voltage. Examples of the lithium-containing complex oxides having a spinel structure include LiMn₂O₄ and compounds in which part of Mn in LiMn₂O₄ is replaced by Ni, Cr, Co, Fe, Ti, Si, Al, Mg, or the like, such as LiNi_{0.5}Mn_{1.5}O₄. One of these may be used, or two or more of these may be used in combination. In addition, as the positive electrode active material, preferably, LiNiO₂ is further used in addition to LiMn₂O₄ and/or a compound in which part of Mn in LiMn₂O₄ is replaced by Ni, Cr, Co, Fe, Ti, Si, Al, Mg, or the like. The amount of LiNiO₂ blended based on the total of LiMn₂O₄ and/or the compound in which part of Mn in LiMn₂O₄ is replaced by Ni, Cr, Co, Fe, Ti, Si, Al, Mg, or the like and LiNiO₂ is preferably 1% by mass or more and 30% by mass or less, more preferably 3% by mass or more and 20% by mass or less, and further preferably 5% by mass or more and 15% by mass or less. Whether the lithium-containing complex oxide has a spinel structure or not can be determined by X-ray structure analysis.

As the method for making the positive electrode, for example, the positive electrode can be made by providing a positive electrode active material on a positive electrode current collector. Specifically, for example, the positive electrode can be made by mixing a positive electrode active material, a conductivity-providing agent, a binding agent, and a solvent, such as N-methyl-2-pyrrolidone (NMP), and coating a positive electrode current collector with the mixture.

As the conductivity-providing agent, for example, powders of carbon materials, metal substances, such as aluminum, and conductive oxides can be used. As the binding agent, polyvinylidene fluoride (PVDF) and the like can be used. As the positive electrode current collector, metal thin films mainly containing aluminum and the like can be used in terms of conductivity and thermal conductivity. The amount of the conductivity-providing agent added can be set to 1 to 10% by mass, and can be set to 3 to 5% by mass. The amount of the binding agent added can be set to 1 to 20% by mass.

As the electrolytic solution comprising an additive, a solution in which the additive and a lithium salt are dissolved in a solvent can be used. It is preferred that the solvent is stable at the oxidation-reduction potential of lithium in repeated charge and discharge, and has flowability in which the positive electrodes and the negative electrodes can be sufficiently immersed, because longer life of the secondary battery can be promoted. As the solvent, aprotic organic solvents, such as cyclic carbonates, such as propylene carbonate (PC), ethylene carbonate (EC), and butylene carbonate (BC), chain carbonates, such as dimethyl carbonate (DMC), diethyl carbonate (DEC), ethyl methyl carbonate (EMC), and dipropyl carbonate (DPC) (however, the cyclic carbonates and chain carbonates do not include the cyclic halogenated carbonates and the unsaturated carbonates mentioned as examples of the additive), aliphatic carboxylates, such as methyl formate, methyl acetate, and ethyl propionate, γ-lactones, such as γ-butyrolactone, chain ethers, such as 1,2-diethoxyethane (DEE) and ethoxymethoxyethane (EME), cyclic ethers, such as tetrahydrofuran and 2-methyltetrahydrofuran, dimethyl sulfoxide, formamide, acetamide, dimethylformamide, dioxolanes, such as 1,3-dioxolane, acetonitrile, propylnitrile, nitromethane, ethyl monoglyme, phosphate triester, trimethoxymethane, dioxolane derivatives, 1,3-dimethyl-2-imidazolidinone, 3-methyl-2-oxazolidinone, propylene carbonate derivatives, tetrahydrofuran derivatives, ethyl ether, anisole, N-methylpyrrolidone, chain halogenated carbonates, halogenated carboxylates, and other halogenated compounds excluding cyclic halogenated carbonates, can be used. One of these solvents may be used, or two or more of these solvents can also be mixed and used.

Examples of the lithium salt include LiPF₆, LiAsF₆, LiAlCl₄, LiClO₄, LiBF₄, LiSbF₆, LiCF₃SO₃, LiC₄F₉CO₃, LiC₄F₉SO₃, LiC(CF₃SO₂)₃, LiN(CF₃SO₂)₂, LiN(C₂F₅SO₂)₂, LiB₁₀Cl₁₀, lower aliphatic lithium carboxylates, chloroborane lithium, lithium tetraphenylborate, LiBr, LiI, LiSCN, LiCl, imides, quaternary ammonium salts, and boron fluorides. One of these lithium salts may be used, or two or more of these lithium salts may be used in combination.

The concentration of the additive in the electrolytic solution is preferably 0.1 to 10% by mass, more preferably 0.3 to 5% by mass, and further preferably 0.5 to 3% by mass. By setting the concentration to 0.1% by mass or more, a film having sufficient performance can be formed. In addition, by setting the concentration to 10% by mass or less, an increase in the thickness of the film can be suppressed, and an increase in resistance value can be prevented.

The concentration of the lithium salt in the electrolytic solution can be set, for example, to 0.2 to 2 mol/L. By setting the concentration of the lithium salt to 0.2 mol/L or more, sufficient electrical conductivity can be obtained. In addition, by setting the concentration of the lithium salt to 2 mol/L or less, an increase in density and viscosity can be suppressed.

The method for applying a potential to at least one positive electrode between the positive electrodes until a potential equal to or less than a potential at which the additive is reductively decomposed is reached is not particularly limited. For example, when the number of positive electrodes is two, examples of the method include a method of inserting a reference electrode during the assembly of a secondary battery before applying the potential (hereinafter referred to as a pre-treatment secondary battery), connecting two positive electrodes and the reference electrode to a potentiostat, and controlling the potential of the positive electrode by the potentiostat to a potential equal to or less than the potential at which the additive is reductively decomposed. Specifically, one positive electrode as a working electrode (hereinafter also abbreviated as W), another positive electrode as a counter electrode (hereinafter also abbreviated as C), and a reference electrode (hereinafter also abbreviated as R) are connected to a potentiostat, and the potential of the working electrode (W) is controlled to a potential equal to or less than the potential at which the additive is reductively decomposed. Thus, the additive is reductively decomposed on the working electrode (W), and a film is formed on the positive electrode. The reference electrode (R) is not particularly limited, and, for example, lithium metal, silver metal, and ferrocene can be used. The use of the reference electrode is not essential, and the secondary battery according to the present exemplary embodiment can be manufactured without the reference electrode because the potential of the positive electrode can be controlled by the patterns of the applied voltage and the current depending on the type and concentration of the additive, the configuration of the electrodes, and the like.

The potential applied to the positive electrode is appropriately selected so that a potential equal to or less than the potential at which the additive is reductively decomposed is reached. A specific reduction potential at which the additive is reductively decomposed is as described above. The potential applied to the positive electrode is preferably 0.1 V or more, more preferably 0.2 V or more, lower than the potential at which the additive is reductively decomposed.

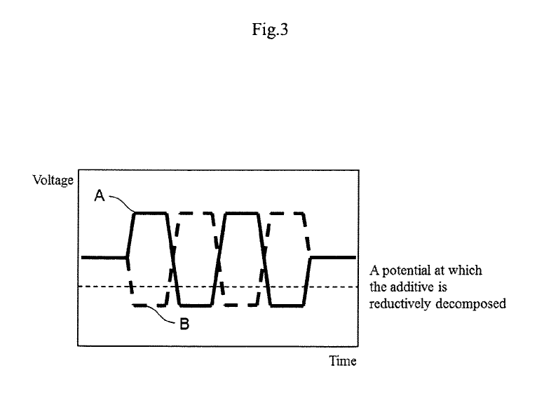

When the positive electrode active material contained in the positive electrode is a lithium-containing complex oxide of spinel structure, it is preferred that when a potential equal to or less than the potential at which the additive is reductively decomposed is applied to the positive electrodes, the potential is alternately applied. The alternate application is a method of alternately applying a potential between the positive electrodes, and is a method of applying a potential by repeating a cycle in which a potential is applied to one positive electrode for a fixed time, then the connections of the positive electrodes are reversed, the potential is applied to the other positive electrode for the fixed time, and the connections of the positive electrodes are reversed again. For example, a potential as shown in FIG. 3 is applied to one positive electrode A and the other positive electrode B. FIG. 3 is a graph showing time on the horizontal axis and voltage on the vertical axis, and a potential is alternately applied so that either one of the positive electrode A and the positive electrode B reaches a potential equal to or less than a potential at which the additive is reductively decomposed.

In addition, when the positive electrode active material contained in the positive electrode is a lithium-containing complex oxide of spinel structure, it is preferred that when a potential equal to or less than the potential at which the additive is reductively decomposed is applied to the positive electrode, the potential is intermittently applied. The intermittent application is a method of applying a potential by repeating a cycle in which a potential is applied for a fixed period, and then, the application of the potential is stopped for a fixed period.

Particularly, it is preferred that alternate and intermittent application in which both alternate application and intermittent application are performed is performed. When a potential is alternately and intermittently applied, for example, a cycle is repeated in which a potential is applied to one positive electrode for a fixed period, then the application of the potential is stopped for a fixed period, the connections of the positive electrodes are reversed, then the potential is applied to the other positive electrode for a fixed period, the application of the potential is stopped for a fixed period, and the connections of the positive electrodes are reversed again.

When the secondary battery includes three or more positive electrodes, the method of alternate application is not particularly limited. For example, when the secondary battery includes an even number of positive electrodes, a potential can be alternately applied using two positive electrodes as one set. On the other hand, when the secondary battery includes an odd number of positive electrodes, a potential can also be alternately applied using two positive electrodes as one set, but, it is preferred that a potential is sequentially applied because the current density may be nonuniform. For example, when the secondary battery includes three positive electrodes (A, B, and C), a potential can be applied with the combination of two positive electrodes sequentially changed (+/−: A/B, B/C, C/A, . . . ). In terms of being able to form a more uniform film, it is preferred that the secondary battery includes an even number of positive electrodes using the positive electrodes as the outermost layers.

When a lithium-containing complex oxide having a spinel structure is used as the positive electrode active material, the insertion reaction of lithium into the positive electrode active material occurs in parallel with the reduction reaction of the additive, and the spinel structure may be broken. The reduction reaction of the additive is diffusion-controlled, and therefore, by alternately applying a potential to the positive electrodes and/or intermittently applying a potential to the positive electrode, a short-time reduction reaction is repeated, and diffusion time can be given to the additive, when the positive electrode active material is a lithium-containing complex oxide of spinel structure. Therefore, the reduction reaction of the additive can be caused prior to the insertion reaction of lithium into the positive electrode active material. Thus, the breakage of the spinel structure due to the insertion of lithium can be prevented, and the cycle characteristics are improved.

The potential application time per application in alternately, intermittently, or alternately and intermittently applying a potential is preferably 0.01 to 10 seconds, more preferably 0.1 to 5 seconds. By setting the potential application time to 0.01 seconds or more, the film can be prevented from dissolving before growing, and the production efficiency of film formation is improved. In addition, by setting the potential application time to 10 seconds or less, the insertion of lithium into the positive electrode active material can be sufficiently prevented. By increasing the temperature of the electrolytic solution, the potential application time can also be shortened.

The time of stopping the application of a potential in intermittently or alternately and intermittently applying the potential is preferably 0.01 to 1000 seconds, more preferably 1 to 100 seconds. By setting the time of stopping the application of a potential to 0.01 seconds or more, sufficient additive diffusion time can be ensured. In addition, by setting the time of stopping the application of a potential to 1000 seconds or less, the production efficiency of the film is improved.

The accumulated time of the time of applying a potential and the time of stopping the application of the potential in alternately, intermittently, or alternately and intermittently applying the potential can be set, for example, to 1 second to 100 minutes.

When the electrolytic solution contains a lithium salt, the potential applied to the positive electrode is preferably equal to or more than a potential at which lithium is inserted into the positive electrode active material contained in the positive electrode in terms of preventing a decrease in the performance of the positive electrode active material. The insertion of lithium into the positive electrode active material theoretically occurs at 2.8 V. But, actually, the insertion reaction of lithium is very slow at this potential, and the insertion of lithium occurs from around 1.3 V. Therefore, the potential applied to the positive electrode is preferably 1.3 V or more. However, when the-described alternate application and/or intermittent application is performed, a potential equal to or less than the potential at which lithium is inserted into the positive electrode active material may be applied, and 1.3 V or less may be applied. But, in order to prevent Li ions from being reduced to Li metal and deposited, a potential higher than 0 V, that is, a potential exceeding 0 V, preferably a potential of 0.1 V or more, more preferably 0.2 V or more, can be applied. In addition, when FEC is used for the additive, alternate application and/or intermittent application is preferably performed because the reduction potential (V vs Li/Li⁺) of FEC is 0.34 V. The potential at which lithium is inserted into the positive electrode active material can be measured by the cyclic voltammetry method.

The temperature of the electrolytic solution in the pre-treatment secondary battery in applying a potential to the positive electrode is preferably −20 to 60° C., more preferably 0 to 40° C., though depending on the type of the electrolytic solution.

As the negative electrode active material that the negative electrode according to the secondary battery according to the present exemplary embodiment includes, materials capable of intercalating and releasing lithium can be used. As the negative electrode active material, for example, silicon-based materials, carbon-based materials, metals, and metal oxides can be used. Examples of the silicon-based materials include Si and silicon oxide, such as SiO and SiO₂. Examples of the carbon-based materials include graphite, amorphous carbon, and hard carbon. Examples of the metals include metals, such as Li, Sn, Al, Pb, S, Zn, Cd, Sb, In, Bi, and Ag, and alloys of two or more thereof. Examples of the metal oxides include tin oxide, aluminum oxide, indium oxide, zinc oxide, lithium oxide, lithium iron oxide, tungsten oxide, molybdenum oxide, copper oxide, tin oxide, such as SnO and SnO₂, titanium oxide, such as TiO₂, niobium oxide, LiₓTi₂₋ₓO₄ (1≦x≦4/3), Li₄Ti₅O₁₂, lead oxide, such as PbO₂ and Pb₂O₅, V-containing oxides, Sb-containing oxides, Fe-containing oxides, and Co-containing oxides. The negative electrode active material may include a metal sulfide, such as SnS or FeS₂, a polyacene or polythiophene, or lithium nitride, such as Li₅(Li₃N), Li₇MnN₄, Li₃FeN₂, Li₂₅Co_{0.5}N, or Li₃CoN, or the like. One of these can be used, or two or more of these can be used in combination.

The negative electrode can be made, for example, by mixing a negative electrode active material, a conductivity-providing agent, and a binding agent, and coating a negative electrode current collector with the mixture. As the conductivity-providing agent, for example, powders of carbon materials, such as carbon black and acetylene black, and conductive oxides can be used. One of these may be used, or two or more of these can also be used in combination. As the binding agent, polyvinylidene fluoride (PVDF), vinylidene fluoride-hexafluoropropylene copolymers, vinylidene fluoride-tetrafluoroethylene copolymers, styrene-butadiene copolymerized rubbers, polytetrafluoroethylene, acrylic resins, polypropylene, polyethylene, polyimides, polyamides, polyacrylates, and the like can be used. One of these may be used, or two or more of these can also be used in combination. As the negative electrode current collector, metal thin films containing at least one or more of metals, such as copper, aluminum, titanium, nickel, silver, and iron, as materials can be used. Examples of its shape include foil, a flat plate shape, and a mesh shape. The thickness of the negative electrode current collector can be set, for example, to 4 to 100 μm, and is preferably 5 to 30 μm in order to increase energy density. The amount of the conductivity-providing agent added can be set to 1 to 10% by mass. The amount of the binding agent added can be set to 0.1 to 20% by mass.

The negative electrode can be made, for example, by coating a negative electrode current collector by a doctor blade method, a die coater method, or the like using a slurry obtained by kneading a negative electrode active material, a conductivity-providing agent, and a binding agent with a solvent, such as N-methyl-2-pyrrolidone (NMP), to form a coating film. Further, the negative electrode can also be rolled to provide a coated electrode plate, or directly pressed to provide a pressed electrode plate. In addition, after the coating, the coating film may be dried to form a negative electrode active material layer.

The materials for the positive electrode tab, the negative electrode tab, and the reference electrode tab are not particularly limited. In terms of conductivity and thermal conductivity, for example, at least one or more of Al, Cu, phosphor bronze, Ni, Ti, Fe, brass, stainless, and the like can be used.

The separator is not particularly limited as long as it suppresses the contact between the positive electrode and the negative electrode, does not inhibit the transmission of charged bodies, and has durability to the electrolytic solution. As the material for the separator, polyolefin-based microporous films, such as polypropylene (PP) and polyethylene, cellulose, polyethylene terephthalate, polyimides, polyamides, glass, polyfluorocarbon, polyvinylidene fluoride, and the like can be used. These can be used as porous films, woven fabrics, nonwoven fabrics, and the like.

As the outer package, those that have strength capable of stably holding the positive electrodes, the negative electrodes, the separators, and the electrolytic solution, are electrochemically stable for these substances, and have watertightness are preferred. As specific materials, for example, stainless, nickel-plated iron, aluminum, titanium, or alloys or plated materials thereof, or metal-laminated resins can be used. As the resins used in the metal-laminated resins, polyethylene, polypropylene, polyethylene terephthalate, and the like can be used. These may be one-layer or two-or-more-layer structures. In addition, the outer package may be a laminate outer package, a metal can, or the like.

The plurality of positive electrodes and the plurality of negative electrodes disposed opposed to each other with the separators sandwiched therebetween can take the form of a wound type, a laminated type, or the like. In addition, the shape of the secondary battery according to the present exemplary embodiment is not particularly limited, and can be a coin type, a laminate type, a prismatic type, or a cylindrical type.

It is preferred that in the secondary battery according to the present exemplary embodiment, the plurality of positive electrodes are connected to each other outside the outer package without being connected to each other inside the outer package, the outer package contains an electrolytic solution containing an additive, the positive electrodes contain lithium, and at least one of the positive electrodes includes a film formed by the reductive decomposition of the additive on the surface.

For the method for forming a film on the positive electrode surface by the reductive decomposition of the additive, the-described method can be used.

A film being formed on the positive electrode surface by the reductive decomposition of the additive can be confirmed, for example, by observing a change in the elemental composition of the positive electrode surface by XPS (X-ray Photoelectron Spectroscopy).

The thickness of the film formed on the positive electrode surface is preferably 0.1 to 100 nm. By setting the thickness of the film to 0.1 nm or more, the deterioration of the film due to cycles can be prevented. In addition, by setting the thickness of the film to 100 nm or less, the resistance can be decreased, and the battery performance is improved. The thickness of the film can be calculated by combining XPS with Ar sputtering, and measuring sputtering time until the additive-derived elements (for example, carbon, lithium, and fluorine) contained in the film are not observed.

In addition, the film formed by the reductive decomposition of the additive need not completely cover the positive electrode surface, and should cover at least part of the positive electrode surface. The coverage of the positive electrode surface with the film is not particularly limited. It is preferred that the positive electrode surface is covered with the film to the extent that the decomposition of the solvent is not electrochemically observed.

It is preferred that in the secondary battery according to the present exemplary embodiment, the plurality of positive electrodes are connected to each other outside the outer package via an overcurrent protection circuit without being connected to each other inside the outer package, or the plurality of negative electrodes are connected to each other outside the outer package via an overcurrent protection circuit without being connected to each other inside the outer package, or the plurality of positive electrodes are connected to each other outside the outer package via an overcurrent protection circuit without being connected to each other inside the outer package and the plurality of negative electrodes are connected to each other outside the outer package via an overcurrent protection circuit without being connected to each other inside the outer package.

By connecting the plurality of positive electrodes to each other outside the outer package via an overcurrent protection circuit, or connecting the plurality of negative electrodes to each other outside the outer package via an overcurrent protection circuit, or connecting the plurality of positive electrodes to each other outside the outer package via an overcurrent protection circuit and connecting the plurality of negative electrodes to each other outside the outer package via an overcurrent protection circuit, a current flowing through an internal short circuit part is limited to only a current from short-circuited electrodes, and therefore, the amount of heat generation can be kept to a minimum. In the case of secondary batteries used in vehicles, such as automobiles, and large storage secondary batteries used in power systems, particularly, large capacity is required, and therefore, a large number of electrodes are laminated. According to the present exemplary embodiment, also in the case of such large capacity secondary batteries, capacity can be obtained by simply increasing the number of electrodes laminated, and even if an internal short circuit occurs in the central portion of the secondary battery, the electrodes can be efficiently cooled because the metallic electrodes having high thermal conductivity and a high heat dissipation effect are exposed to the outside of the outer package of the secondary battery. In addition, the amount of heat generation is limited to that of energy stored in the short-circuited electrodes, regardless of the capacity of the entire secondary battery, and therefore, the amount of heat generation is limited also in the large capacity secondary batteries.

As the overcurrent protection circuit, a circuit having a current interruption function of interrupting a current when an excess current flows, and a circuit having a current suppression function of suppressing a current when an excess current flows can be used.

As the overcurrent protection circuit having the current interruption function, a power fuse that melts and cuts a circuit when a current equal to or more than a rated current flows, and a thermal fuse that is thermally connected to the inside of the secondary battery, and thereby melts and interrupts a circuit by heat generation occurring inside the secondary battery can be used.

As the overcurrent protection circuit having the current suppression function, a PTC thermistor can be used. In the PTC thermistor, when the temperature increases due to Joule heat generated by an excess current, or heat generated inside the secondary battery, the resistance value increases significantly, and the current can be suppressed. In the case of the overcurrent protection circuit having the current suppression function, the current is not completely interrupted.

When the current value at which the overcurrent protection circuit functions is set to a small value, the safety increases, but the secondary battery performance decreases during rapid charge. In addition, when the current value is small, its resistance increases, and therefore, the performance of the secondary battery decreases. On the other hand, when the current value is set to a large value, the safety may decrease. The current value at which the overcurrent protection circuit functions also differs depending on the specifications of the secondary battery, and therefore can be appropriately set. For example, the current value with respect to the charge capacity of the secondary battery can be set in the range of 0.01 C or more and 200 C or less, can also be set in the range of 0.05 C or more and 100 C or less, and can also be set in the range of 0.1 C or more and 50 C or less.

The temperature at which the overcurrent protection circuit functions also differs depending on the specifications of the secondary battery, and therefore can be appropriately set. For example, the temperature can be set to 60° C. or more and 150° C. or less, and can also be set to 70° C. or more and 140° C. or less, in terms of exceeding the temperature region usually used and not exceeding the temperature region in which the pyrolysis of the electrolytic solution occurs.

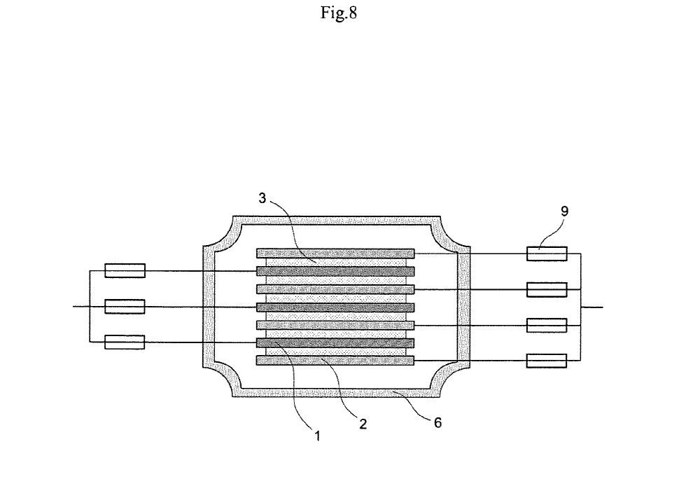

For example, as shown in FIG. 8, a plurality of positive electrodes 1 and a plurality of negative electrodes 2 can be connected to each other outside an outer package 6 via overcurrent protection circuits 9. In FIG. 8, one overcurrent protection circuit 9 is connected to one positive electrode 1 (negative electrode 2), but, for example, a form in which one overcurrent protection circuit 9 is connected to two positive electrodes 1 (negative electrodes 2) may be used. In addition, the overcurrent protection circuits 9 are preferably connected outside the outer package 6, as shown in FIG. 8, in terms of safety.

### [Method for Manufacturing Secondary Battery]

A method for manufacturing a secondary battery according to the present exemplary embodiment is a method for manufacturing a secondary battery including a plurality of positive electrodes and a plurality of negative electrodes in an outer package, including: assembling a pre-connected secondary battery without connecting the plurality of positive electrodes to each other inside the outer package, or without connecting the plurality of negative electrodes to each other inside the outer package, or without connecting the plurality of positive electrodes to each other inside the outer package and without connecting the plurality of negative electrodes to each other inside the outer package; and connecting the plurality of positive electrodes not connected to each other inside the outer package in the pre-connected secondary battery, or connecting the plurality of negative electrodes not connected to each other inside the outer package in the pre-connected secondary battery, or connecting the plurality of positive electrodes not connected to each other inside the outer package in the pre-connected secondary battery and connecting the plurality of negative electrodes not connected to each other inside the outer package in the pre-connected secondary battery, to each other outside the outer package.

It is preferred that the method for manufacturing a secondary battery according to the present exemplary embodiment is the method wherein the outer package contains an electrolytic solution containing an additive and the plurality of positive electrodes contain lithium; the method including assembling a pre-connected secondary battery without connecting the plurality of positive electrodes to each other inside the outer package; applying a potential to at least one positive electrode between the plurality of positive electrodes of the pre-connected secondary battery until a potential equal to or less than a potential at which the additive is reductively decomposed is reached; and connecting the plurality of positive electrodes to each other outside the outer package.

The pre-connected secondary battery means an assembled secondary battery before the plurality of positive electrodes are connected to each other outside the outer package, or before the plurality of negative electrodes are connected to each other outside the outer package, or before the plurality of positive electrodes are connected to each other outside the outer package and the plurality of negative electrodes are connected to each other outside the outer package, and can be made as in the above-described method. The pre-connected secondary battery may be a pre-treatment the secondary battery. The step of applying a potential between the plurality of positive electrodes can be performed by the above-described method for applying a potential until a potential equal to or less than a potential at which the additive is reductively decomposed is reached. Means for achieving the step of connecting the positive electrodes to each other outside the outer package is not particularly limited as long as the plurality of positive electrodes can be connected to each other outside the outer package.

In addition, it is preferred in the method for manufacturing a secondary battery according to the present exemplary embodiment that, in connecting the plurality of positive electrodes not connected to each other inside the outer package in the pre-connected secondary battery, or in connecting the plurality of negative electrodes not connected to each other inside the outer package in the pre-connected secondary battery, or in connecting the plurality of positive electrodes not connected to each other inside the outer package in the pre-connected secondary battery and connecting the plurality of negative electrodes not connected to each other inside the outer package in the pre-connected secondary battery, to each other outside the outer package, the plurality of positive electrodes are connected to each other outside the outer package via an overcurrent protection circuit, or the plurality of negative electrodes are connected to each other outside the outer package via an overcurrent protection circuit, or the plurality of positive electrodes are connected to each other outside the outer package via an overcurrent protection circuit and the plurality of negative electrodes are connected to each other outside the outer package via an overcurrent protection circuit. The type of the overcurrent protection circuit, the method for connecting the overcurrent protection circuit, and the like may be similar to those described above.

Examples of the method for manufacturing a secondary battery according to the present exemplary embodiment include the following method. A laminate, which is obtained by disposing the plurality of positive electrodes, the plurality of negative electrodes, and the reference electrode opposed to each other with separators sandwiched therebetween, and laminating them, is made into a cylindrical or laminated form. This is housed in a battery case, which is an outer package, and immersed in an electrolytic solution so that the plurality of positive electrodes, the plurality of negative electrodes, and the reference electrode come into contact with the electrolytic solution. Then, the battery case is hermetically sealed to obtain a pre-connected secondary battery. At this time, positive electrode tabs, negative electrode tabs, and a reference electrode tab are connected to the plurality of positive electrodes, the plurality of negative electrodes, and the reference electrode, respectively, so as to lead to the outside of the electrode case. In addition, the positive electrode tabs and the negative electrode tabs are exposed to the outside of the electrode case so that the positive electrode tabs do not come into electrical contact with each other and the negative electrode tabs do not come into electrical contact with each other inside the electrode case. Then, the step of applying a potential between the positive electrodes until a potential equal to or less than a potential at which the additive is reductively decomposed is reached, and the step of connecting the positive electrode tabs to each other and the negative electrode tabs to each other outside the outer package via an overcurrent protection circuit as described above are performed. Thus, the secondary battery according to the present exemplary embodiment can be manufactured.

### [Assembled Battery]

An assembled battery according to the present exemplary embodiment includes a plurality of the secondary batteries according to the present exemplary embodiment. Specifically, the assembled battery according to the present exemplary embodiment is fabricated with at least two or more secondary batteries according to the present exemplary embodiment connected in series, in parallel, or both. By connecting the secondary batteries in series or in parallel, capacity and voltage can be freely adjusted. The number of secondary batteries that the assembled battery includes can be appropriately set according to battery capacity and output. The assembled battery according to the present exemplary embodiment can be used for large storage batteries for stationary applications, vehicles described later, and the like.

### [Vehicle]

A vehicle according to the present exemplary embodiment includes the secondary battery according to the present exemplary embodiment. The vehicle according to the present exemplary embodiment may include the assembled battery according to the present exemplary embodiment. Examples of the vehicle according to the present exemplary embodiment include hybrid vehicles, fuel cell vehicles, and electric vehicles (all include four-wheeled vehicles (passenger vehicles, commercial vehicles, such as trucks and buses, light vehicles, and the like) as well as two-wheeled vehicles (motorcycles) and three-wheeled vehicles). These vehicles include the secondary battery according to the present exemplary embodiment, and therefore have enhanced life and high reliability. The vehicles according to the present exemplary embodiment are not limited to automobiles, and may be various power supplies for other vehicles, for example, moving bodies, such as trains.

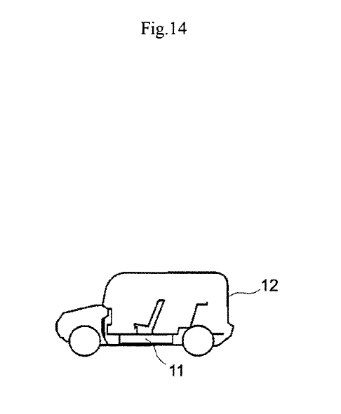

A conceptual diagram of an electric vehicle in which the secondary battery according to the present exemplary embodiment is mounted is shown in FIG. 14. As shown in FIG. 14, in an electric vehicle 12 according to the present exemplary embodiment, an assembled battery 11 including a plurality of the secondary batteries according to the present exemplary embodiment is mounted under a seat in the central portion of the body of the electric vehicle 12. By mounting the assembled battery 11 under the seat, a large interior space and trunk room can be obtained. The place where the assembled battery 11 is mounted is not limited to under the seat, and may be the lower portion of the rear trunk room, or the engine room at the front of the vehicle. The electric vehicle 12 including the assembled battery 11 according to the present exemplary embodiment has high durability, and can provide sufficient output even if used for a long period. Further, the electric vehicle 12 having excellent fuel consumption and running performance can be provided.

### Examples

Examples in the present exemplary embodiment will be described in detail below, but the present exemplary embodiment is not limited to the following Examples.

### Example 1

### Making of Negative Electrode

A massive synthetic graphite powder having an average particle diameter of 20 μm, an average aspect ratio of 1.4, and a specific surface area of 1 m²/g as a negative electrode active material, an acrylic modified resin (trade name: LSR-7, manufactured by Hitachi Chemical Co., Ltd.) as a binding agent, and carbon black as a conductivity-providing agent in the proportion of 96:3:1 in terms of a solid mass ratio were uniformly dispersed in N-methylpyrrolidone (NMP) to make a slurry. A copper foil having a thickness of 15 μm, which was a negative electrode current collector, was coated with this slurry, and then, the NMP was evaporated at 125° C. for 10 minutes to form a negative electrode active material layer. A negative electrode active material layer was also similarly formed on the back surface, and the copper foil with the negative electrode active material layers was pressed to make a negative electrode coated on both surfaces. The amount of the negative electrode mixture per unit area after drying was 0.008 g/cm². The binding agent is an acrylic modified resin containing 80% by mass or more of a repeating unit derived from a nitrile group-containing monomer.

(Making of Positive Electrode)

A LiMn₂O₄ powder having an average particle diameter of 10 μm as a positive electrode active material, PVDF as a binding agent, and a carbonaceous powder as a conductivity-providing agent at a mass ratio of 92:4:4 were uniformly dispersed in NMP to make a slurry. 20 μm thick aluminum foil, which was a positive electrode current collector, was coated with this slurry, and then, the NMP was evaporated at 125° C. for 10 minutes to form a positive electrode active material layer and make a positive electrode coated on one surface. The amount of the positive electrode mixture per unit area after drying was 0.025 g/cm².

(Making of Reference Electrode)

Lithium metal was deposited on copper foil to make a reference electrode.

(Preparation of Electrolytic Solution)

A solution obtained by dissolving 1 mol/L of LiPF₆ as an electrolyte in a mixed solvent of EC:DEC=30:70 (% by volume) was used as an electrolytic solution R. A solution obtained by mixing this solution with 1% by mass of LiBOB as an additive was used as an electrolytic solution A.

(Making of Pre-Treatment Secondary Battery)

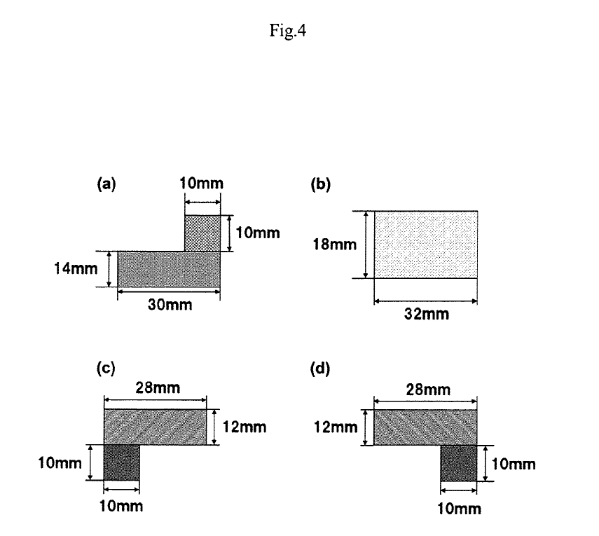

The negative electrode made was cut into one piece having a shape shown in FIG. 4(a). In this, the protruding 10 mm×10 mm portion is a portion uncoated with the slurry for connecting a negative electrode tab. The positive electrode made was cut into one piece having a shape shown in FIG. 4(c) and one piece having a shape shown in FIG. 4(d). In these, the protruding 10 mm×10 mm portions are portions uncoated with the slurry for connecting positive electrode tabs. The reference electrode made was cut into one piece of 5 mm×15 mm. In this, one side of the reference electrode, 5 mm×10 mm, is a lithium-undeposited portion for connecting a reference electrode tab. A separator containing polyethylene and polypropylene was cut into two pieces having a shape shown in FIG. 4(b). As outer packages, an aluminum laminate film was cut into two pieces of 45 mm×50 mm.

A 10 mm×30 mm positive electrode tab made of aluminum was ultrasonically welded to each of the two positive electrodes with a length of 5 mm. The positive electrode tabs were not connected to each other. In addition, a 10 mm×30 mm negative electrode tab made of nickel was ultrasonically welded to the negative electrode with a length of 5 mm. Similarly, a reference electrode tab made of nickel having the same size as the negative electrode tab was ultrasonically welded.

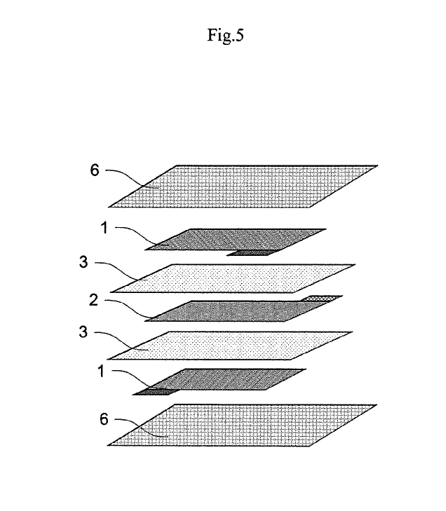

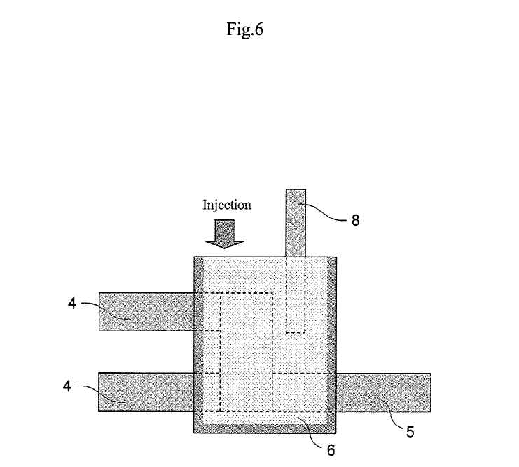

The cut negative electrode 2, positive electrodes 1, separators 3, and outer packages 6 were laminated in the order shown in FIG. 5. Then, as shown in FIG. 6, three sides of the outer packages 6 were adhered with a width of 5 mm by heat sealing so that the two positive electrode tabs 4 and the negative electrode tab 5 were exposed to the outside of the outer packages 6, to provide the bag-shaped outer package 6. At this time, the two positive electrode tabs 4 were arranged so as not to be connected to each other inside the outer package 6. The reference electrode was inserted into the bag-shaped laminate outer package so as not to come into contact with the electrode laminate, and arranged so that the reference electrode tab 8 was exposed to the outside of the outer package 6. As shown in FIG. 6, the electrolytic solution A was injected for vacuum impregnation, and then, the opening was sealed with a width of 5 mm by heat sealing under reduced pressure to make a pre-treatment secondary battery.

(Film Formation on Positive Electrodes)

The two positive electrode tabs exposed to the outside were connected to a potentiostat as a working electrode (W) and a counter electrode (C), respectively. In addition, the reference electrode tab was connected to the potentiostat as a reference electrode (R).

An operation in which by the potentiostat, a potential of 1.5 V was applied to the working electrode (W) for 1 second, the application was stopped for 10 seconds, then the connections of the working electrode (W) and the counter electrode (C) were reversed, a potential of 1.5 V was applied to the working electrode (W) for 1 second, and the application was stopped for 10 seconds was repeated 1800 times. Thus, a film was formed on the surfaces of the two positive electrodes. The film due to the reductive decomposition of LiBOB being formed on the surface of each positive electrode was confirmed by observing a change in the surface elemental composition of each positive electrode by XPS.

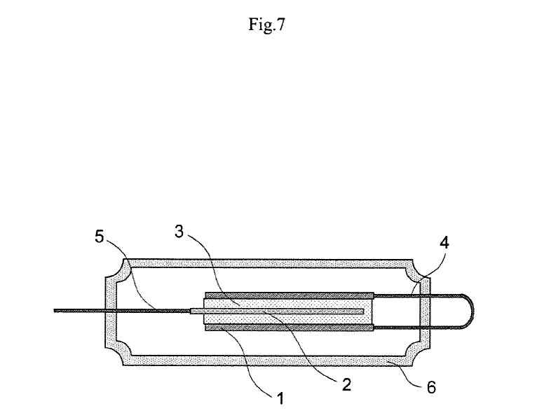

Then, the two positive electrode tabs were connected outside the outer package. Thus, a secondary battery shown in FIG. 7 was made.

(Cycle Test)

For the secondary battery made, a cycle test was performed. Specifically, a charge and discharge cycle in which the secondary battery was charged at a constant current of 60 mA to 4.2 V, then subjected to 4.2 V constant voltage charge for 2.5 hours in total, and then subjected to constant current discharge at 60 mA to 3.0 V was repeated 500 times. The ratio of discharge capacity after 500 cycles to initial discharge capacity was obtained as a capacity retention rate (%). The test temperature was set to 60° C. for the purpose of a deterioration test and an acceleration test in a higher temperature environment. The result is shown in Table 1.

(Nail Penetration Test)

The secondary battery made was charged at a constant current of 60 mA to 4.2 V, then a nail (diameter 1 mm) was passed through the central portions of the electrodes, and the temperature of the surface was measured. The result is shown in Table 1.

### Example 2

A mixture obtained by mixing the electrolytic solution R of Example 1 with 1% by mass of VC as an additive was used as an electrolytic solution B. Operations similar to those of Example 1 were performed except that the electrolytic solution B was used instead of the electrolytic solution A. A film due to the reductive decomposition of VC being formed on the surface of each positive electrode was confirmed by XPS. The results are shown in Table 1.

### Example 3

A mixture obtained by mixing the electrolytic solution R of Example 1 with 1% by mass of MMDS as an additive was used as an electrolytic solution C, and the electrolytic solution C was used instead of the electrolytic solution A. In addition, the potential alternately and intermittently applied to the working electrode (W) was set to 1.3 V. Except these, operations similar to those of Example 1 were performed. A film due to the reductive decomposition of MMDS being formed on the surface of each positive electrode was confirmed by XPS. The results are shown in Table 1.

### Example 4

In film formation on the positive electrodes, when a potential was applied to the working electrode (W), a potential of 1.5 V was applied to the working electrode (W) for 30 minutes, then the connections of the working electrode (W) and the counter electrode (C) were reversed, and a potential of 1.5 V was applied to the working electrode (W) for 30 minutes. Except this, operations similar to those of Example 1 were performed. A film due to the reductive decomposition of LiBOB being formed on the surface of each positive electrode was confirmed by XPS. The results are shown in Table 1.

### Example 5

As a positive electrode active material, a mixture of a LiMn₂O₄ powder having an average particle diameter of 10 μm and a LiNiO₂ powder having an average particle diameter of 10 μm (the mixing ratio (mass ratio) of LiMn₂O₄ to LiNiO₂: 90/10) was used. Except this, operations similar to those of Example 1 were performed. A film due to the reductive decomposition of LiBOB being formed on the surface of each positive electrode was confirmed by XPS. The results are shown in Table 1.

### Example 6

Operations similar to those of Example 1 were performed except that the electrolytic solution R was used instead of the electrolytic solution A. The results are shown in Table 1.

### Example 7

Operations similar to those of Example 1 were performed except that in film formation on the positive electrodes, the positive electrodes were allowed to leave for 30 minutes without a potential being applied to the working electrode (W). The results are shown in Table 1.

### Example 8

Operations similar to those of Example 6 were performed except that in film formation on the positive electrodes, the positive electrodes were allowed to leave for 30 minutes without a potential being applied to the working electrode (W). The results are shown in Table 1.

### Example 9

Operations similar to those of Example 2 were performed except that in film formation on the positive electrodes, the positive electrodes were allowed to leave for 30 minutes without a potential being applied to the working electrode (W). The results are shown in Table 1.

### Example 10

Operations similar to those of Example 3 were performed except that in film formation on the positive electrodes, the positive electrodes were allowed to leave for 30 minutes without a potential being applied to the working electrode (W). The results are shown in Table 1.

### Example 11

Operations similar to those of Example 5 were performed except that in film formation on the positive electrodes, the positive electrodes were allowed to leave for 30 minutes without a potential being applied to the working electrode (W). The results are shown in Table 1.

### Example 12

In film formation on the positive electrodes, an operation in which by a potentiostat, a potential of 1.5 V was applied to the working electrode (W) for 1 second, and the application was stopped for 10 seconds was repeated 1800 times. Then, an operation in which the connections of the working electrode (W) and the counter electrode (C) were reversed, a potential of 1.5 V was applied to the working electrode (W) for 1 second, and the application was stopped for 10 seconds was repeated 1800 times. Except these, operations similar to those of Example 1 were performed. A film due to the reductive decomposition of LiBOB being formed on the surface of each positive electrode was confirmed by XPS. The results are shown in Table 1.

### Comparative Example 1

Two positive electrodes were disposed in a direction in which the uncoated portions overlap, and the uncoated portions were ultrasonically welded. In addition, a 10 mm×30 mm positive electrode tab made of aluminum was also ultrasonically welded to the uncoated portions of the positive electrodes with an overlap of 5 mm. Except these, a pre-treatment secondary battery was made as in Example 1.

The positive electrode tab, a negative electrode tab, and a reference electrode tab were connected to a potentiostat as a working electrode (W), a counter electrode (C), and a reference electrode (R), respectively. An operation in which by the potentiostat, a potential of 1.3 V was applied to the working electrode (W) for 1 second, and the application was stopped for 10 seconds was repeated 1800 times. Thus, a film was formed on the surface of the positive electrode. The film due to the reductive decomposition of LiBOB being formed on the surface of positive electrode was confirmed by XPS.

For the secondary battery made, a cycle test similar to that of Example 1 was performed. In this Comparative Example, in the cycle test, copper dendrites formed, and a short circuit occurred, and therefore, the capacity retention rate could not be measured.

### Comparative Example 2

A pre-treatment secondary battery was made as in Comparative Example 1 except that the electrolytic solution R was used instead of the electrolytic solution A. Operations similar to those of Example 6 were performed except that in film formation on the positive electrodes, the positive electrodes were allowed to leave for 30 minutes without a potential being applied to the working electrode (W). The results are shown in Table 1.

The surface temperature after the nail penetration test was measured. The surface temperature reached 50 to 60° C. in Comparative Example 2, whereas the surface temperature was 30 to 40° C. in Example 8. When higher capacity is achieved by multilayering electrodes, the amount of heat generation is more than the amount of heat dissipation from the laminate outer package surface, and the temperature inside the secondary battery is higher. In Example 8, heat was efficiently dissipated from the positive electrodes via the positive electrode current collectors made of aluminum and the positive electrode tabs made of aluminum having high thermal conductivity, and therefore, the safety of the secondary battery was improved.

TABLE 1

| | | | | | | | Surface |
|---|---|---|---|---|---|---|---|
| | | | | | Connection of | | temperature |
| | | | | Additive | positive electrode | Capacity | after nail |
| | Positive electrode | | | for positive | tabs inside | retention | penetration |
| | active material | Potential (V) | Application method | electrode film | outer package | rate (%) | test (° C.) |
| Example 1 | LiMn₂O₄ | 1.5 | Alternate and intermittent application | LiBOB | Without | 45 | 30-40 |
| | | | (between positive electrodes) | | | | |
| Example 2 | LiMn₂O₄ | 1.5 | Alternate and intermittent application | VC | Without | 43 | 30-40 |
| | | | (between positive electrodes) | | | | |
| Example 3 | LiMn₂O₄ | 1.3 | Alternate and intermittent application | MMDS | Without | 40 | 30-40 |
| | | | (between positive electrodes) | | | | |
| Example 4 | LiMn₂O₄ | 1.5 | Alternate application (between | LiBOB | Without | 43 | 30-40 |
| | | | positive electrodes) | | | | |
| Example 5 | LiMn₂O₄/LiNiO₂ | 1.5 | Alternate and intermittent application | LiBOB | Without | 47 | 30-40 |
| | | | (between positive electrodes) | | | | |
| Example 6 | LiMn₂O₄ | 1.5 | Alternate and intermittent application | No | Without | 28 | 30-40 |
| | | | (between positive electrodes) | | | | |
| Example 7 | LiMn₂O₄ | No application | — | LiBOB | Without | 32 | 30-40 |
| Example 8 | LiMn₂O₄ | No application | — | No | Without | 30 | 30-40 |
| Example 9 | LiMn₂O₄ | No application | — | VC | Without | 35 | 30-40 |
| Example 10 | LiMn₂O₄ | No application | — | MMDS | Without | 36 | 30-40 |
| Example 11 | LiMn₂O₄/LiNiO₂ | No application | — | LiBOB | Without | 34 | 30-40 |
| Example 12 | LiMn₂O₄ | 1.5 | Intermittent application (between | LiBOB | Without | 42 | 30-40 |
| | | | positive electrodes) | | | | |
| Comparative | LiMn₂O₄ | 1.3 | Alternate and intermittent application | LiBOB | With | — | 50-60 |
| Example 1 | | | (between positive and negative | | | | |
| | | | electrodes) | | | | |
| Comparative | LiMn₂O₄ | No application | — | No | With | 30 | 50-60 |
| Example 2 | | | | | | | |

### Example 13

### Making of Negative Electrode

A negative electrode was made as in Example 1.

(Making of Positive Electrode)

A positive electrode was made as in Example 1 except that a positive electrode active material layer was also formed on the back surface similarly to the front surface, and this was pressed to make a positive electrode coated on both surfaces.

(Preparation of Electrolytic Solution)

An electrolytic solution R was prepared as in Example 1.

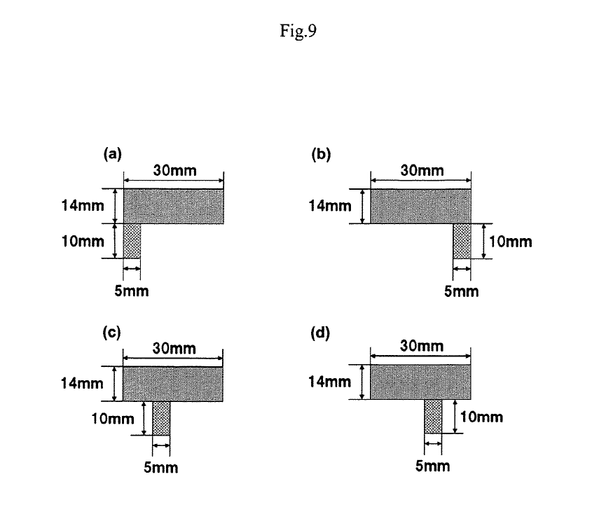

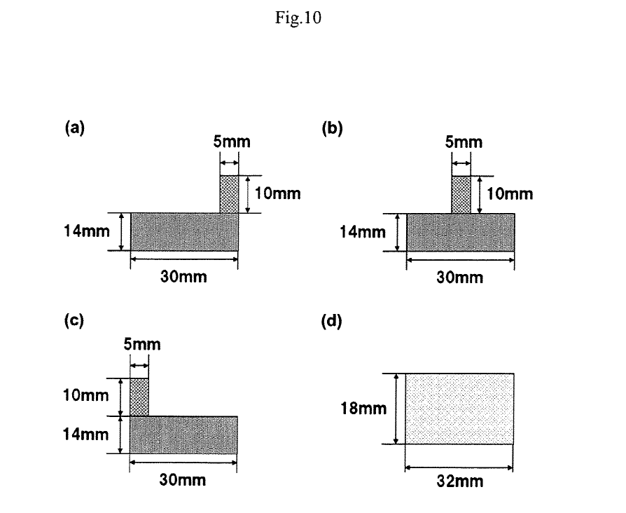

(Making of Secondary Battery) The negative electrode made was cut into one piece having a shape shown in FIG. 9(a), one piece having a shape shown in FIG. 9(b), one piece having a shape shown in FIG. 9(c), and one piece having a shape shown in FIG. 9(d), four pieces in total. In these, the protruding 10 mm×5 mm portions are slurry-uncoated portions for connecting negative electrode tabs. The positive electrode made was cut into one piece having a shape shown in FIG. 10(a), one piece having a shape shown in FIG. 10(b), and one piece having a shape shown in FIG. 10(c), three pieces in total. In these, the protruding 10 mm×5 mm portions are slurry-uncoated portions for connecting positive electrode tabs. A separator containing polyethylene and polypropylene was cut into six pieces having a shape shown in FIG. 10(d). As outer packages, an aluminum laminate film was cut into two pieces of 45 mm×50 mm.

A 5 mm×30 mm positive electrode tab made of aluminum was ultrasonically welded to each of the three positive electrodes with a length of 5 mm. In addition, a 5 mm×30 mm negative electrode tab made of nickel was ultrasonically welded to each of the four negative electrodes with a length of 5 mm. As a lead for a short circuit test, a tab made of nickel (1 mm×30 mm) was ultrasonically welded to one negative electrode that was the outermost layer. In addition, a tab made of aluminum (1 mm×30 mm) was ultrasonically welded to the positive electrode opposed to this negative electrode. No tabs were connected to each other.

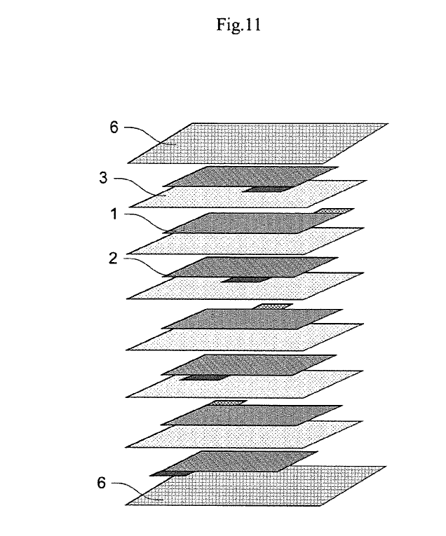

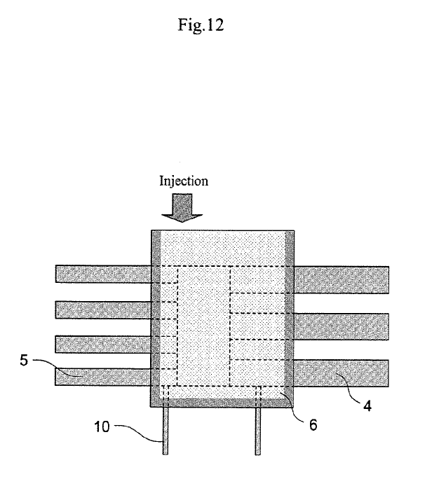

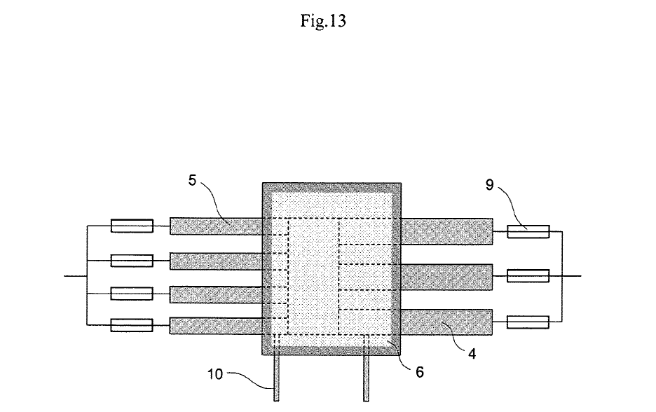

The cut negative electrodes 2, positive electrodes 1, separators 3, and outer packages 6 were laminated in the order shown in FIG. 11. Then, as shown in FIG. 12, three sides of the outer packages 6 were adhered with a width of 5 mm by heat sealing so that the three positive electrode tabs 4 and the four negative electrode tabs 5 were exposed to the outside of the outer packages 6, to provide the bag-shaped outer package 6. At this time, the three positive electrode tabs 4 were arranged so as not to be connected to each other inside the outer package 6, and the four negative electrode tabs 5 were arranged so as not to be connected to each other inside the outer package 6. As shown in FIG. 12, the electrolytic solution R was injected for vacuum impregnation, and then, the opening was sealed with a width of 5 mm by heat sealing under reduced pressure. Then, the positive electrode tabs 4 were connected to each other outside the outer package 6 via PTC thermistors 9, and the negative electrode tabs 5 were connected to each other outside the outer package 6 via PTC thermistors 9. Thus, a secondary battery shown in FIG. 13 was made.

(Internal Short Circuit Test)

Conditioning in which the secondary battery made was charged at 0.2 C to 4.2 V, and discharged at 0.2 C to 2.5 V was performed. Then, the secondary battery was charged at a current of 0.2 C to an upper limit voltage of 4.3 V. The lead for a short circuit test was bonded, and the temperature of the secondary battery surface was measured. The result is shown in Table 2. A temperature range measured as the highest temperature reached is shown in Table 2.

### Example 14

As positive electrodes, three electrodes having a shape shown in FIG. 10(a) were made, and one positive electrode tab made of aluminum and the slurry-uncoated portions of the three positive electrodes were superimposed and ultrasonically welded. Except these, a secondary battery was made as in Example 13, and the internal short circuit test was performed. The result is shown in Table 2.

### Example 15

As negative electrodes, four electrodes having a shape shown in FIG. 9(a) were made, and one negative electrode tab made of nickel and the slurry-uncoated portions of the four negative electrodes were superimposed and ultrasonically welded. Except these, a secondary battery was made as in Example 13, and the internal short circuit test was performed. The result is shown in Table 2.

### Example 16

A secondary battery was made as in Example 13 except that no PTC thermistor was used, and the internal short circuit test was performed. The result is shown in Table 2.

### Example 17

A secondary battery was made as in Example 14 except that no PTC thermistor was used, and the internal short circuit test was performed. The result is shown in Table 2.

### Example 18

A secondary battery was made as in Example 15 except that no PTC thermistor was used, and the internal short circuit test was performed. The result is shown in Table 2.

### Comparative Example 3

As positive electrodes, three electrodes having a shape shown in FIG. 10(a) were made, and one positive electrode tab made of aluminum and the slurry-uncoated portions of the three positive electrodes were superimposed and ultrasonically welded. As negative electrodes, four electrodes having a shape shown in FIG. 9(a) were made, and one negative electrode tab made of nickel and the slurry-uncoated portions of the four negative electrodes were superimposed and ultrasonically welded. In addition, no PTC thermistor was used. Except these, a secondary battery was made as in Example 13, and the internal short circuit test was performed. The result is shown in Table 2.

In the secondary batteries according to Examples 13 to 18 in which the plurality of positive electrodes were connected to each other outside the outer package without being connected to each other inside the outer package, or the plurality of negative electrodes were connected to each other outside the outer package without being connected to each other inside the outer package, or the plurality of positive electrodes were connected to each other outside the outer package without being connected to each other inside the outer package and the plurality of negative electrodes were connected to each other outside the outer package without being connected to each other inside the outer package, the highest temperature reached decreased due to the heat dissipation effect, compared with the secondary battery according to Comparative Example 3. In addition, in the secondary batteries according to the Examples and the Comparative Example including the PTC thermistor, the PTC thermistor operated, and the highest temperature reached decreased further.

TABLE 2

| | External connection, | | | |
|---|---|---|---|---|
| | internal connection | | | Highest |
| | Positive | Negative | | temperature |
| | electrode | electrode | PTC thermistor | reached (° C.) |
| Example 13 | External | External | With | 20-30 |
| | connection | connection | | |
| Example 14 | Internal | External | With | 30-40 |
| | connection | connection | | |
| Example 15 | External | Internal | With | 30-40 |
| | connection | connection | | |
| Example 16 | External | External | Without | 40-50 |
| | connection | connection | | |
| Example 17 | Internal | External | Without | 50-60 |
| | connection | connection | | |
| Example 18 | External | Internal | Without | 50-60 |
| | connection | connection | | |
| Comparative | Internal | Internal | Without | 60-70 |
| Example 3 | connection | connection | | |

This application claims priority to Japanese Patent Application No. 2011-148174 filed Jul. 4, 2011, and Japanese Patent Application No. 2011-202092 filed Sep. 15, 2011, the entire disclosure of which is incorporated herein.

While the invention of this application has been described with reference to the exemplary embodiments and the Examples, the invention of this application is not limited to the exemplary embodiments and Examples. Various changes that can be understood by those skilled in the art can be made in the configuration and details of the invention of this application within the scope of the invention of this application.

### REFERENCE SIGNS LIST

1 positive electrode
2 negative electrode
3 separator
4 positive electrode tab
5 negative electrode tab
6 outer package
7 insulating coat
8 reference electrode tab
9 overcurrent protection circuit (PTC thermistor)
10 lead for short circuit test
11 assembled battery
12 electric vehicle

1. A secondary battery comprising a plurality of positive electrodes and a plurality of negative electrodes in an outer package,
wherein the plurality of positive electrodes are connected to each other outside the outer package without being connected to each other inside the outer package, or
wherein the plurality of negative electrodes are connected to each other outside the outer package without being connected to each other inside the outer package, or
wherein the plurality of positive electrodes are connected to each other outside the outer package without being connected to each other inside the outer package, and the plurality of negative electrodes are connected to each other outside the outer package without being connected to each other inside the outer package.

2. The secondary battery according to claim 1, wherein the plurality of positive electrodes connected to each other outside the outer package without being connected to each other inside the outer package, or the plurality of negative electrodes connected to each other outside the outer package without being connected to each other inside the outer package, or the plurality of positive electrodes connected to each other outside the outer package without being connected to each other inside the outer package and the plurality of negative electrodes connected to each other outside the outer package without being connected to each other inside the outer package, are extended to the outside of the outer package in different directions from each other.

3. The secondary battery according to claim 1,
wherein the plurality of positive electrodes are connected to each other outside the outer package without being connected to each other inside the outer package,
the outer package comprises an electrolytic solution comprising an additive,
the plurality of positive electrodes comprise lithium, and
the plurality of positive electrodes are connected to each other outside the outer package after a potential is applied to at least one positive electrode between the plurality of positive electrodes until a potential equal to or less than a potential at which the additive is reductively decomposed is reached.

4. The secondary battery according to claim 3, wherein the plurality of positive electrodes comprise a lithium-containing complex oxide of spinel structure as a positive electrode active material.

5. The secondary battery according to claim 4, wherein the application of a potential to the positive electrode is at least one of alternate application and intermittent application.

6. The secondary battery according to claim 3, wherein the electrolytic solution comprises a lithium salt, and the potential applied to the positive electrode is a potential equal to or more than a potential at which lithium is inserted into the positive electrode active material comprised in the positive electrode.

7. The secondary battery according to claim 3, wherein the additive is at least one selected from the group consisting of a cyclic disulfonate, a cyclic sulfonate, a cyclic sulfone, a cyclic halogenated carbonate, an unsaturated carbonate, an acid anhydride, a cyclic imide, lithium bisoxalate borate, lithium difluoro[oxalato-O,O′]borate, a sulfite, an unsaturated ester, glycolide, and cyanofuran.

8. The secondary battery according to claim 1,
wherein the plurality of positive electrodes are connected to each other outside the outer package without being connected to each other inside the outer package,
the outer package contains an electrolytic solution comprising an additive,
the plurality of positive electrodes comprise lithium, and
at least one of the plurality of positive electrodes comprises a film formed by reductive decomposition of the additive on its surface.

9. The secondary battery according to claim 8, wherein the plurality of positive electrodes comprise a lithium-containing complex oxide of spinel structure as a positive electrode active material.

10. The secondary battery according to claim 8, wherein the additive is at least one selected from the group consisting of a cyclic disulfonate, a cyclic sulfonate, a cyclic sulfone, a cyclic halogenated carbonate, an unsaturated carbonate, an acid anhydride, a cyclic imide, lithium bisoxalate borate, lithium difluoro[oxalato-O,O′]borate, a sulfite, an unsaturated ester, glycolide, and cyanofuran.

11. The secondary battery according to claim 1, wherein the plurality of negative electrodes comprise graphite as a negative electrode active material.

12. The secondary battery according to claim 1, wherein the plurality of negative electrodes comprise a negative electrode current collector comprising copper.

13. The secondary battery according to claim 1, wherein the plurality of positive electrodes are connected to each other outside the outer package via an overcurrent protection circuit without being connected to each other inside the outer package, or
wherein the plurality of negative electrodes are connected to each other outside the outer package via an overcurrent protection circuit without being connected to each other inside the outer package, or
wherein the plurality of positive electrodes are connected to each other outside the outer package via an overcurrent protection circuit without being connected to each other inside the outer package, and the plurality of negative electrodes are connected to each other outside the outer package via an overcurrent protection circuit without being connected to each other inside the outer package.

14. The secondary battery according to claim 13, wherein the overcurrent protection circuit has a current interruption function.

15. The secondary battery according to claim 14, wherein the overcurrent protection circuit is a power fuse or a thermal fuse.

16. The secondary battery according to claim 13, wherein the overcurrent protection circuit has a current suppression function.

17. The secondary battery according to claim 16, wherein the overcurrent protection circuit is a PTC thermistor.

18. An assembled battery comprising a plurality of the secondary batteries according to claim 1.

19. A vehicle comprising the secondary battery according to claim 1.

20. A method for manufacturing a secondary battery comprising a plurality of positive electrodes and a plurality of negative electrodes in an outer package, comprising:
assembling a pre-connected secondary battery without connecting the plurality of positive electrodes to each other inside the outer package, or without connecting the plurality of negative electrodes to each other inside the outer package, or without connecting the plurality of positive electrodes to each other inside the outer package and without connecting the plurality of negative electrodes to each other inside the outer package; and
connecting the plurality of positive electrodes not connected to each other inside the outer package in the pre-connected secondary battery, or connecting the plurality of negative electrodes not connected to each other inside the outer package in the pre-connected secondary battery, or connecting the plurality of positive electrodes not connected to each other inside the outer package in the pre-connected secondary battery and connecting the plurality of negative electrodes not connected to each other inside the outer package in the pre-connected secondary battery, to each other outside the outer package.

21. The method for manufacturing a secondary battery according to claim 20, wherein the plurality of positive electrodes connected to each other outside the outer package without being connected to each other inside the outer package, or the plurality of negative electrodes connected to each other outside the outer package without being connected to each other inside the outer package, or the plurality of positive electrodes connected to each other outside the outer package without being connected to each other inside the outer package and the plurality of negative electrodes connected to each other outside the outer package without being connected to each other inside the outer package, are extended to the outside of the outer package in different directions from each other.

22. The method for manufacturing a secondary battery according to claim 20, wherein the outer package comprises an electrolytic solution comprising an additive, and the plurality of positive electrodes comprise lithium, the method comprising:
assembling a pre-connected secondary battery without connecting the plurality of positive electrodes to each other inside the outer package;
applying a potential to at least one positive electrode between the plurality of positive electrodes of the pre-connected secondary battery until a potential equal to or less than a potential at which the additive is reductively decomposed is reached; and
connecting the plurality of positive electrodes to each other outside the outer package.

23. The method for manufacturing a secondary battery according to claim 22, wherein the plurality of positive electrodes comprise a lithium-containing complex oxide of spinel structure as a positive electrode active material.

24. The method for manufacturing a secondary battery according to claim 23, wherein in applying a potential to the positive electrode, the application of a potential to the positive electrode is at least one of alternate application and intermittent application.

25. The method for manufacturing a secondary battery according to claim 22,
wherein the electrolytic solution comprises a lithium salt, and
in applying a potential to the positive electrode, the potential applied to the positive electrode is a potential equal to or more than a potential at which lithium is inserted into the positive electrode active material comprised in the positive electrode.

26. The method for manufacturing a secondary battery according to claim 22, wherein the additive is at least one selected from the group consisting of a cyclic disulfonate, a cyclic sulfonate, a cyclic sulfone, a cyclic halogenated carbonate, an unsaturated carbonate, an acid anhydride, a cyclic imide, lithium bisoxalate borate, lithium difluoro[oxalato-O,O′]borate, a sulfite, an unsaturated ester, glycolide, and cyanofuran.

27. The method for manufacturing a secondary battery according to claim 20, wherein the plurality of negative electrodes comprise graphite as a negative electrode active material.

28. The method for manufacturing a secondary battery according to claim 20, wherein the plurality of negative electrodes comprise a negative electrode current collector comprising copper.

29. The method for manufacturing a secondary battery according to claim 20,
wherein, in connecting the plurality of positive electrodes not connected to each other inside the outer package in the pre-connected secondary battery, or in connecting the plurality of negative electrodes not connected to each other inside the outer package in the pre-connected secondary battery, or in connecting the plurality of positive electrodes not connected to each other inside the outer package in the pre-connected secondary battery and connecting the plurality of negative electrodes not connected to each other inside the outer package in the pre-connected secondary battery, to each other outside the outer package, the plurality of positive electrodes are connected to each other outside the outer package via an overcurrent protection circuit, or the plurality of negative electrodes are connected to each other outside the outer package via an overcurrent protection circuit, or the plurality of positive electrodes are connected to each other outside the outer package via an overcurrent protection circuit and the plurality of negative electrodes are connected to each other outside the outer package via an overcurrent protection circuit.

30. The method for manufacturing a secondary battery according to claim 29, wherein the overcurrent protection circuit has a current interruption function.

31. The method for manufacturing a secondary battery according to claim 30, wherein the overcurrent protection circuit is a power fuse or a thermal fuse.

32. The method for manufacturing a secondary battery according to claim 29, wherein the overcurrent protection circuit has a current suppression function.

33. The method for manufacturing a secondary battery according to claim 32, wherein the overcurrent protection circuit is a PTC thermistor.
